(19) United States
(12) Patent Application Publication
(10) Pub. No.: US 2016/0294833 A1
(43) Pub. Date: Oct. 6, 2016

(54) SOCIAL COMMUNICATION SYSTEM AND METHOD THEREOF

(71) Applicant: National Tsing Hua University, Hsinchu City (TW)

(72) Inventors: Shan-Hung Wu, Hsinchu (TW); Yan-Fu Liu, Taichung City (TW); Meng-Ren Chen, Hsinchu (TW); You-Jhih Wong, Keelung City (TW)

(21) Appl. No.: 14/719,339

(22) Filed: May 22, 2015

(30) Foreign Application Priority Data
Mar. 30, 2015 (TW) 104110290

(51) Int. Cl. H04L 29/06; H04W 12/08; H04L 12/58; G06F 17/30

(52) U.S. Cl. CPC H04L 63/101; G06F 17/30345; G06F 17/30876; H04W 12/08; H04L 51/32

(57) ABSTRACT

A social communication system and a method thereof are provided. The system includes a server apparatus and a user device. The user device transmits an authorization request to the server apparatus, and the server apparatus inquires an authorized individual whether to agree a user to access a friendship list of the authorized individual. When the authorized individual agrees the user to access the friendship list of the authorized individual, the friendship list of the authorized individual is added to a FOF database. The user device transmits an anonymous social communication service request to the server apparatus to obtain an anonymous social communication service for the user and the authorized individual. Besides, when the service is stopped, the server apparatus inquires both of the authorized individual and the user whether they agree to provide their profiles to each other as the basis for the friendship.

### CROSS-REFERENCE TO RELATED APPLICATION

This application claims the priority benefit of Taiwan application serial no. 104110290, filed on Mar. 30, 2015. The entirety of the above-mentioned patent application is hereby incorporated by reference herein and made a part of this specification.

### BACKGROUND OF THE INVENTION

1. Field of the Invention

The invention relates to a social communication technique, and particularly relates to a social communication system and a method thereof.

2. Description of Related Art

General instant communication services (for example, Line, WhatsApp, WeChat, etc.) only allow a user to communicate/chat with a known friend, and the user cannot conveniently get to know new friends outside an original social circle. Social network services based on strangers (for example, online dating sites) adopt a practice of chatting through random pairing, which probably faces security disadvantages such as lack of privacy, the paired individual has fake personal information, completely irrelevant paired individual, and fake paired individuals (for example, for crime message distribution, advertising), etc., or encounters a predicament such as lack of a common topic with the paired individual, etc., which leads to step back of the users due to the security factors.

Moreover, by searching the paired individuals only through personal files, the user is easy to miss a soul mate, deceived by information counterfeiters, or a female user suffers from unfair treatment, etc., such that the user has to face danger and frustration when the user wants to expand the social circle. Therefore, it is a target of effort for those skilled in the art to provide a more secure channel to the user to make friend with those usually having no chance to meet.

### SUMMARY OF THE INVENTION

The invention is directed to a social communication system and a method thereof, by which a user is able to contact all friends of the user, and selects an individual from all friends of each friend of the user to carry out an anonymous social communication service, and adds each other as friends after the anonymous social communication service is ended, so as to increase a trust basis to enhance security.

The invention provides a social communication system including a server apparatus and a user device. The user device sends an authorization request to the server apparatus, and the server apparatus inquires an authorized individual whether to agree a user to access a friendship list of the authorized individual, where the authorized individual is in a friendship list of the user. When an authorization reply for replying the authorization request by the authorized individual is received, and the authorization reply indicates that the authorized individual agrees the user to access the friendship list of the authorized individual, the friendship list of the authorized individual is added to a friends of friends (FOF) database of the user. Moreover, the user device sends an anonymous social communication service request to the server apparatus to obtain an anonymous social communication service for the user and a candidate individual. The candidate individual is one of a plurality of individuals in the FOF database of the user. Moreover, when the anonymous social communication service is stopped, the server apparatus inquires both of the user and the candidate individual whether they agree to provide their profiles to each other to serve as a basis for friendship of the user and the candidate individual.

In an embodiment of the invention, when the user and the candidate individual all agree to provide their profiles to each other, the server apparatus adds the user to the friendship list of the candidate individual and the candidate individual to the friendship list of the user.

In an embodiment of the invention, when the anonymous social communication service is provided, a predetermined time is set to start a countdown, and when the countdown of the predetermined time is finished, the anonymous social communication service is stopped.

In an embodiment of the invention, when the anonymous social communication service is ended, the server apparatus stores a course record of the anonymous social communication service.

In an embodiment of the invention, when the anonymous social communication service is stopped, the server apparatus inquires both of the user and the candidate individual whether they agree to continue the anonymous social communication service, and when one of the user and the candidate individual agree to continue the anonymous social communication service, and the other one agrees to provide the profile, the server apparatus continues the anonymous social communication service without providing the respective profiles of the user and the candidate individual to each other.

In an embodiment of the invention, when the anonymous social communication service is stopped, the server apparatus inquires both of the user and the candidate individual whether they agree to end the anonymous social communication service, and when one of the user and the candidate individual agrees to end the anonymous social communication service, the server apparatus ends the anonymous social communication service.

In an embodiment of the invention, when the server apparatus provides the anonymous social communication service, the server apparatus provides at least one mutual friend profile to the user and the candidate individual to serve as a communication basis of the user and the candidate individual.

According to another aspect, the invention provides a social communication method adapted to a user device. In the method, an authorization request is sent to inquire an authorized individual whether to agree a user to access a friendship list of the authorized individual, where the authorized individual is in a friendship list of the user. When an authorization reply for replying the authorization request by the authorized individual is received, and the authorization reply indicates that the authorized individual agrees the user to access the friendship list of the authorized individual, the friendship list of the authorized individual is added to a friends of friends (FOF) database of the user. Then, an anonymous social communication service request is sent to obtain an anonymous social communication service for the user and a candidate individual, where the candidate individual is one of a plurality of individuals in the FOF database of the user. Thereafter, when the anonymous social communication service is stopped, both of the user and the candidate individual are inquired whether they agree to provide their profiles to each other to serve as a basis for friendship.

Referring the above descriptions for other implantation details of the social communication method, and details thereof are not repeated.

According to another aspect, the invention provides a social communication method adapted to a server apparatus. In the method, an authorized individual is inquired whether to agree a user to access a friendship list of the authorized individual according to a received authorization request, where the authorized individual is in a friendship list of the user. When an authorization reply for replying the authorization request by the authorized individual is received, and the authorization reply indicates that the authorized individual agrees the user to access the friendship list of the authorized individual, the friendship list of the authorized individual is added to a friends of friends (FOF) database of the user. Then, an anonymous social communication service is provided for the user and a candidate individual according to a received anonymous social communication service request, where the candidate individual is one of a plurality of individuals in the FOF database of the user. Thereafter, when the anonymous social communication service is stopped, both of the user and the candidate individual are inquired whether they agree to provide their profiles to each other to serve as a basis for friendship.

Referring the above descriptions for other implantation details of the social communication method, and details thereof are not repeated.

Based on the above descriptions, according to the social communication system and the method thereof provided by the invention, the user accepts all friends of the friends of the user to establish the FOF database, and selects an individual from the FOF database to carry out the anonymous social communication service. When the anonymous social communication service is ended, the user and the individual of the anonymous social communication service can make friend to each other. In this way, a well known friend serves as a middleman, so as to increase a trust basis of the user and the individual to improve security.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a social communication system according to an exemplary embodiment of the invention.

FIG. 2 is a schematic diagram of friendship lists according to an exemplary embodiment of the invention.

FIG. 3 is a flowchart illustrating a social communication method according to an exemplary embodiment of the invention.

FIG. 4A and FIG. 4B are schematic diagrams of a user interface of the social communication system according to an exemplary embodiment of the invention.

FIG. 5 is a schematic diagram of a user interface of the social communication system according to another exemplary embodiment of the invention.

FIG. 6 is an example of a social communication system according to an exemplary embodiment of the invention.

FIG. 7 is a flowchart illustrating a social communication method according to an exemplary embodiment of the invention.

FIG. 8 is a flowchart illustrating a social communication method according to another exemplary embodiment of the invention.

### DESCRIPTION OF EMBODIMENTS

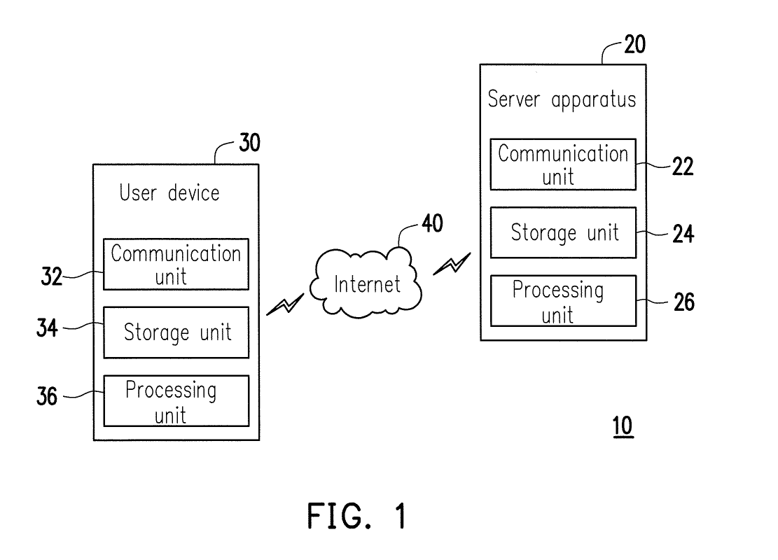

FIG. 1 is a schematic diagram of a social communication system according to an exemplary embodiment of the invention. Referring to FIG. 1, the social communication system 10 includes a server apparatus 20 and a user device 30. In the social communication system 10, the server apparatus 20 and the user device 30 can be connected through a network connection technique and the Internet 40, so as to communicate with each other through the Internet 40.

The server apparatus 20 is, for example, a computer device having computation capability such as a file server, a database server, an application server, a workstation or a personal computer, etc. The server apparatus 20 includes a communication unit 22, a storage unit 24 and a processing unit 26, and types and functions thereof are as follows.

The communication unit 22 is, for example, a wireless communication module supporting wireless communication protocols such as wireless fidelity (Wi-Fi), worldwide interoperability for microwave access (WiMAX), 3^{rd} generation partnership project (3GPP) standard, bluetooth, etc., or a wired communication module supporting Ethernet, optical fiber, etc, or other wired communication module having the wired transmission capability. The server apparatus 20 is connected to the Internet 40 through the communication unit 22 according to the network connection technique, and communicates with the user device 30.

The storage unit 24 is, for example, a random access memory (RAM), a read-only memory (ROM), a flash memory or a similar device or a combination of the above devices. In the present exemplary embodiment, the storage unit 24 is used for recording software program codes of a social communication method. The software program codes stored in the storage unit 24 can be loaded into the processing unit 26 of the server apparatus 20, and the processing unit 26 executes functions of the social communication system. It should be noticed that the storage unit 24 of the present embodiment is not limited to be a single memory device, and the above modules can be separately stored in two or more than two memory devices of the same or different types.

The processing unit 26 is coupled to the communication unit 22 and the storage unit 24. The processing unit 26 is, for example, a central processing unit (CPU) having a single core or a plurality of cores, or a general purpose or special purpose microprocessor, a digital signal processor (DSP), a programmable controller, an application specific integrated circuit (ASIC) or other similar device or a combination of the above devices. In the present exemplary embodiment, the processing unit 26 is used for accessing software programs recorded in the storage unit 24, so as to execute the social communication method of the invention. The processing unit 26 of the present embodiment is not limited to be a single processing device, and two or more than two processing devices can be used to commonly execute the above social communication method.

The user device 30 is, for example, an electronic device such as a smart phone, a personal digital assistant (PDA), a tablet computer, a notebook computer, a multimedia player, etc., which is not limited by the invention. The user device 30 includes a communication unit 32, a storage unit 34 and a processing unit 36. Types and functions of the communication unit 32, the storage unit 34 and the processing unit 36 of the user device 30 are the same or similar to the communication unit 22, the storage unit 24 and the processing unit 26 of the server apparatus 20, so that details thereof are not repeated.

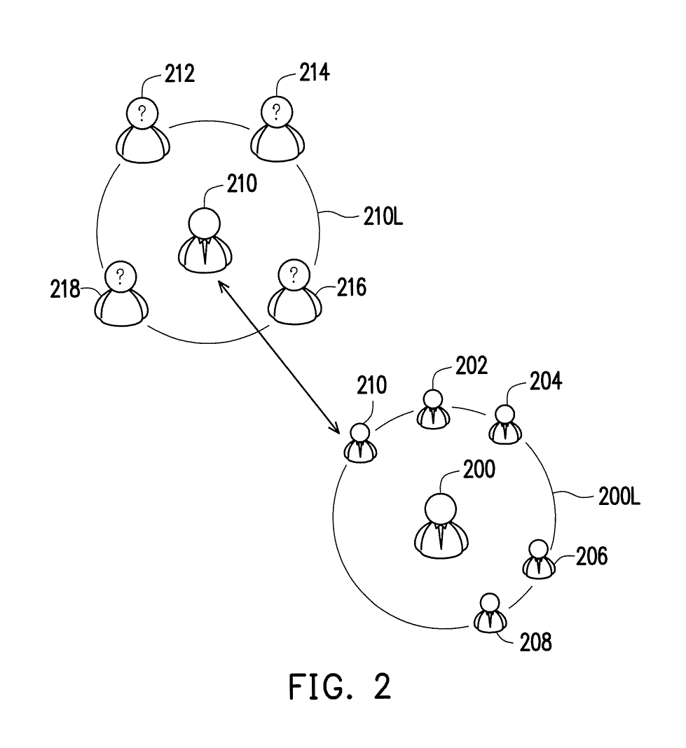

FIG. 2 is a schematic diagram of friendship lists according to an exemplary embodiment of the invention. Referring to FIG. 2, a user 200 can establish a friendship list 200L related to the user 200 to connect all of friends of the user. For example, the friendship list 200L includes a friend 202, a friend 204, a friend 206, a friend 208 and a friend 210. The user 200 can select the friend 210 as an authorized individual according to the friendship list 200L, i.e., the authorized individual (i.e., the friend 210) is in the friendship list 200L of the user 200. The user 200 inquires the authorized individual (i.e., the friend 210) whether to agree the user 200 to access a friendship list 210L of the authorized individual (i.e., the friend 210). The friendship list 210L includes a friend 212, a friend 214, a friend 216 and a friend 218. After the authorized individual (i.e., the friend 210) agrees, all of the friends in the friendship list 210L of the authorized individual (i.e., the friend 210) are added to a friends of friends (FOF) database of the user. The social communication system 10 pairs the user 200 to carry out an anonymous social communication service according to the FOF database of the user.

In detail, the friendship list can be created according to a friend list of the user in a social networking service (SNS). For example, the user has different friend lists in different SNSs, and the friendship list can be one of or a combination of the friend lists. Moreover, the friendship list can be created according to a friend list of the user in an instant messaging (IM) service. In addition, the friendship list can also be created according to a contacts list of the user. The creation method and the content of the friendship list is not limited by the invention. Namely, by creating the FOF database according to the friendship lists created according to the aforementioned method, the content of the FOF database can be implemented through cross platforms and cross applications, and is not limited to a single source.

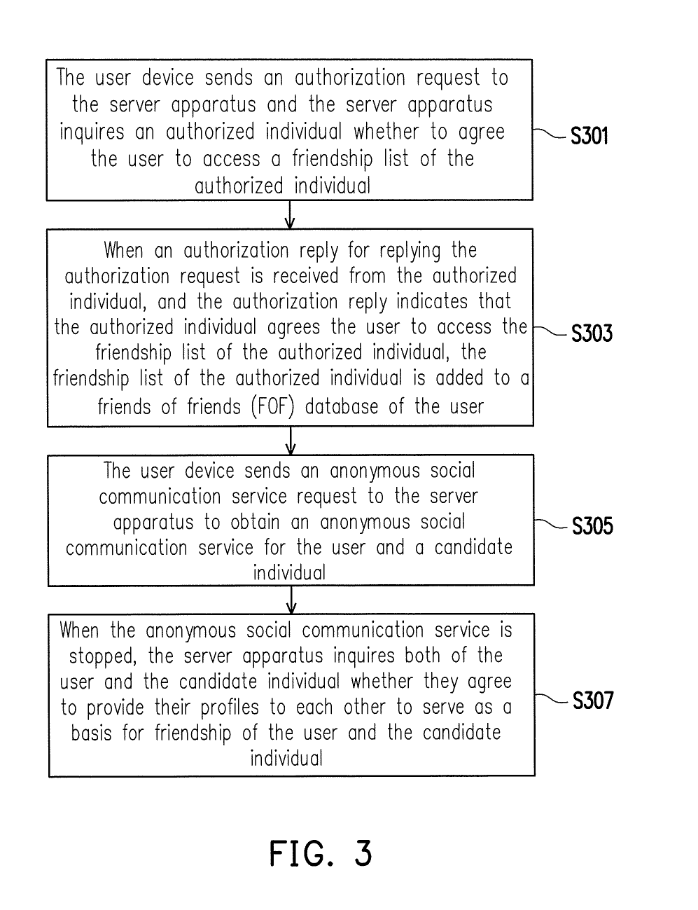

FIG. 3 is a flowchart illustrating a social communication method according to an exemplary embodiment of the invention. Referring to FIG. 3, the social communication method of the present exemplary embodiment is adapted to the social communication system 10 of FIG. 1, and steps of the present exemplary embodiment are described below with reference of the server apparatus 20 and the user device 30 of FIG.

First, in step S301, the user sends an authorization request to the server apparatus 20 by using the user device 30, and the server apparatus 20 inquires an authorized individual whether to agree the user to access a friendship list of the authorized individual.

In step S303, when an authorization reply for replying the authorization request is received from the authorized individual, and the authorization reply indicates that the authorized individual agrees the user to access the friendship list of the authorized individual, the friendship list of the authorized individual is added to an FOF database of the user. In detail, the FOF database can be stored in the server apparatus 20.

In step S305, the user device 30 sends an anonymous social communication service request to the server apparatus 20 to obtain an anonymous social communication service for the user and a candidate individual. In detail, the candidate individual is one of a plurality of individuals in the FOF database of the user. For example, the server apparatus 20 can randomly select one candidate individual from the FOF database of the user, and provide the anonymous social communication service for the user and the candidate individual. For another example, the server apparatus 20 can send the anonymous social communication service request to all of the individuals in the FOF database of the user, and takes a first replier as the candidate individual. To be specific, the anonymous social communication service is carried on in an anonymous way to both sides, i.e., neither the user nor the candidate individual knows profile of each other. In detail, the anonymous social communication service can be an instant messaging service, which allows both sides to transmit text, images or video files, which is, for example, implemented based on an extensible messaging and presence protocol (XMPP) technique. Moreover, the anonymous social communication service can also be an instant interactive game.

In step S307, when the anonymous social communication service is stopped, the server apparatus 20 inquires both of the user and the candidate individual whether they agree to provide their profiles to each other to serve as a basis for friendship of the user and the candidate individual. In detail, the user and the candidate individual can suggest to stop the anonymous social communication service at any time during the process of the anonymous social communication service. Moreover, the anonymous social communication service can be time-limited. For example, when the server apparatus 20 provides the anonymous social communication service, the server apparatus 20 can set a predetermined time and starts a countdown, and when the countdown of the predetermined time is finished, the server apparatus 20 stops the anonymous social communication service.

To be specific, regarding the basis of making friends, the user and the candidate individual can decide to make friends with each other and willingness for sharing profiles to each other according to feelings for each other during the period of the anonymous social communication service. When the user and the candidate individual are willing to provide their profiles to each other, the server apparatus 20 adds the user to a friendship list of the candidate individual and adds the candidate individual to a friendship list of the user. Moreover, the user and the candidate individual can also be added to the respective friend lists in a specific social network service or a specific instant communication service, so as to expand the fiend circles of both sides, and greatly increase security.

Moreover, when the anonymous social communication service is stopped, the server apparatus 20 can inquire the user and the candidate individual whether they agree to continue the anonymous social communication service, and when one of the user and the candidate individual agree to continue the anonymous social communication service, and the other one agrees to provide the profile, the server apparatus 20 continues the anonymous social communication service without providing the respective profiles of the user and the candidate individual to each other. Moreover, when the anonymous social communication service is stopped, the server apparatus 20 inquires both of the user and the candidate individual whether they agree to end the anonymous social communication service, and when one of the user and the candidate individual agrees to end the anonymous social communication service, the server apparatus 20 ends the anonymous social communication service, and neither the user nor the candidate individual obtains the other's profile provided by the social communication system 10. In detail, the social communication system 10 of the present invention adopts a conservative decision to protect the individuals of the anonymous social communication service.

TABLE ONE

| | User | | |
|---|---|---|---|
| | | | Agree to end |
| | | Agree to continue | anonymous |
| | | anonymous social | social |
| Candidate | Willing to | communication | communication |
| individual | provide profile | service | service |
| Willing to | Add each other to | continue | end anonymous |
| provide | friendship list | anonymous social | social |
| profile | | communication | communication |
| | | service | service |
| Agree to continue | continue | continue | end anonymous |
| anonymous social | anonymous social | anonymous social | social |
| communication | communication | communication | communication |
| service | service | service | service |
| Agree to end | end anonymous | end anonymous | end anonymous |
| anonymous social | social | social | social |
| communication | communication | communication | communication |
| service | service | service | service |

The table one is a decision table of the anonymous social communication service drawn according to an exemplary embodiment of the invention. When the anonymous social communication service is stopped, the server apparatus 20 sends an inquiry request to the user and the candidate individual. The inquiry request may contain options of whether agree to provide the respective profiles, whether agree to continue the anonymous social communication service, and whether agree to end the anonymous social communication service. Then, according to replies of the user and the candidate individual, the server apparatus 20 selects the most conservative option in the replies of the user and the candidate individual, i.e., takes privacy protection as a priority option. For example, when both of the user and the candidate individual are willing to provide the profiles, the server apparatus 20 provides the respective profiles to each other and adds both sides to the respective friend circles. For example, when one of the user and the candidate individual is willing to provide the profile, and the other one agrees to continue the anonymous social communication service, the server apparatus 20 continues the anonymous social communication service, and restarts the countdown. For example, when one of the user and the candidate individual is willing to provide the profile, and the other one agrees to end the anonymous social communication service, the server apparatus 20 ends the anonymous social communication service. For example, when both of the user and the candidate individual agree to continue the anonymous social communication service, the server apparatus 20 continues the anonymous social communication service, and restarts the countdown. For example, when one of the user and the candidate individual agrees to continue the anonymous social communication service, and the other one agrees to end the anonymous social communication service, the server apparatus 20 ends the anonymous social communication service. For example, when both of the user and the candidate individual agree to end the anonymous social communication service, the server apparatus 20 ends the anonymous social communication service. However, the contents, the numbers and priority sequence of the options in the inquiry request sent to the user and the candidate individual by the server apparatus 20 is not limited by the invention.

In an exemplary embodiment, when the server apparatus 20 provides the anonymous social communication service, the server apparatus 20 can provide at least one mutual friend profile to the user and the candidate individual to serve as a communication basis of the user and the candidate individual. In detail, the communication basis can be a topic for the user and the candidate individual in the social communication service. The user and the candidate individual can respectively obtain the mutual friend profile, and raise a common topic through a mutual friend in the social communication service, so as to enhance the trust basis to improve security.

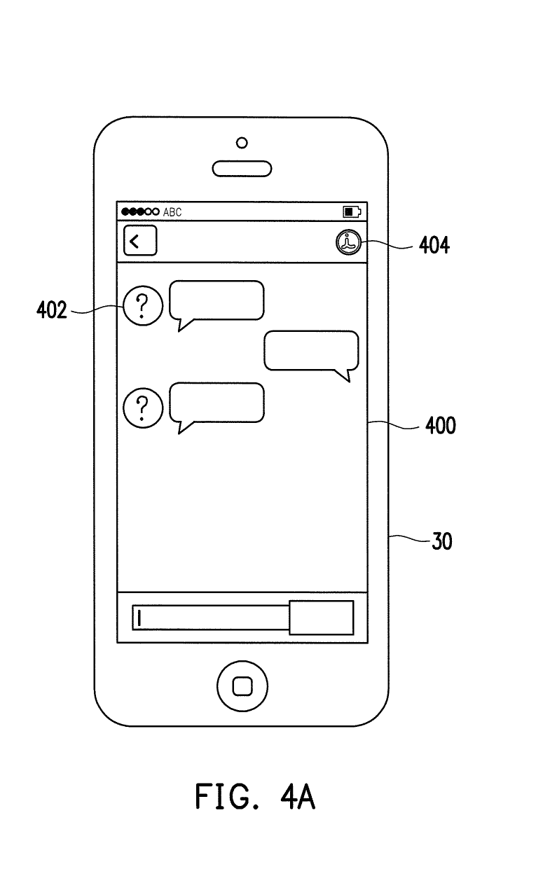

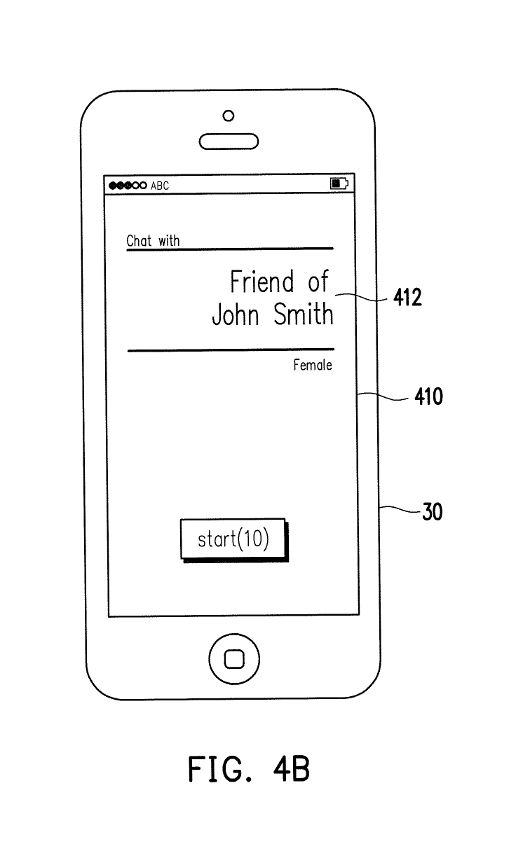

FIG. 4A and FIG. 4B are schematic diagrams of a user interface of the social communication system according to an exemplary embodiment of the invention. The present exemplary embodiment is adapted to the user device 30 in the social communication system 10 of FIG. 1. Referring to FIG. 4A, the mutual friend profile can serve as the communication base for the user and a candidate individual 402 when the user and the candidate individual 402 carry on the anonymous social communication service. For example, in a user interface 400 corresponding to the anonymous social communication service, an icon 404 is clicked to display a user interface 410 of FIG. 4B.

Referring to FIG. 4B, the user and the candidate individual 402 can obtain a text message 412 of the mutual friend profile of the user and the candidate individual 402 in the user interface 410.

In an exemplary embodiment, when the anonymous social communication service is ended, the server apparatus 20 can store a course record of the anonymous social communication service. In detail, the course record can be communication data between the user and the candidate individual in the anonymous social communication service, and the course record is, for example, digital data containing sound, text and images. It should be noticed that when the anonymous social communication service is ended, if the user and the candidate individual do not agree to provide the respective profiles to each other, the course record of the anonymous social communication service does not disclose the respective profiles of the user and the candidate individual. Moreover, even if the user and the candidate individual are again paired and agree to provide the respective profiles, the previous record still does not disclose the respective profile, such that the user and the candidate individual are unable to learn that they had carried on the anonymous social communication service, so as to ensure privacy.

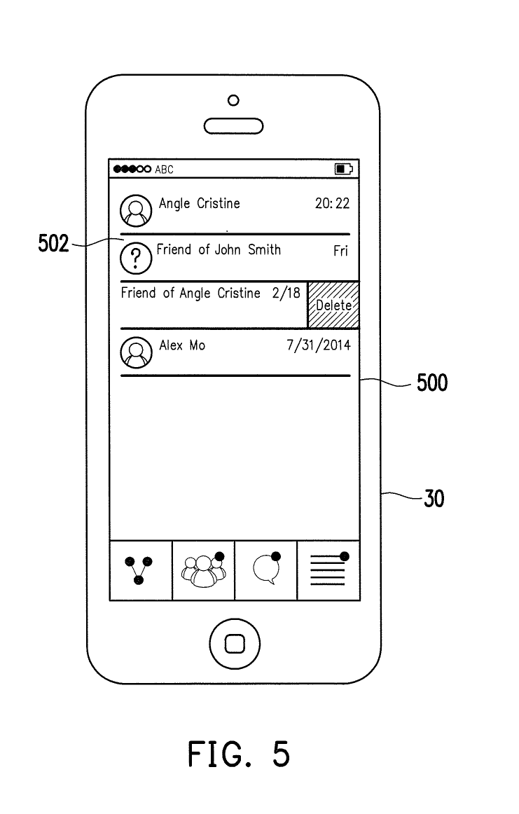

FIG. 5 is a schematic diagram of a user interface of the social communication system according to another exemplary embodiment of the invention. The present exemplary embodiment is adapted to the user device 30 in the social communication system 10 of FIG. 1. Referring to FIG. 5, the course record of the anonymous social communication service can be associated with the user and the candidate individual. The user can view a course record list of all of the social communication services associated with the user from the user interface 500, and the course record list contains the course record 502 of the anonymous social communication service that has been ever carried on.

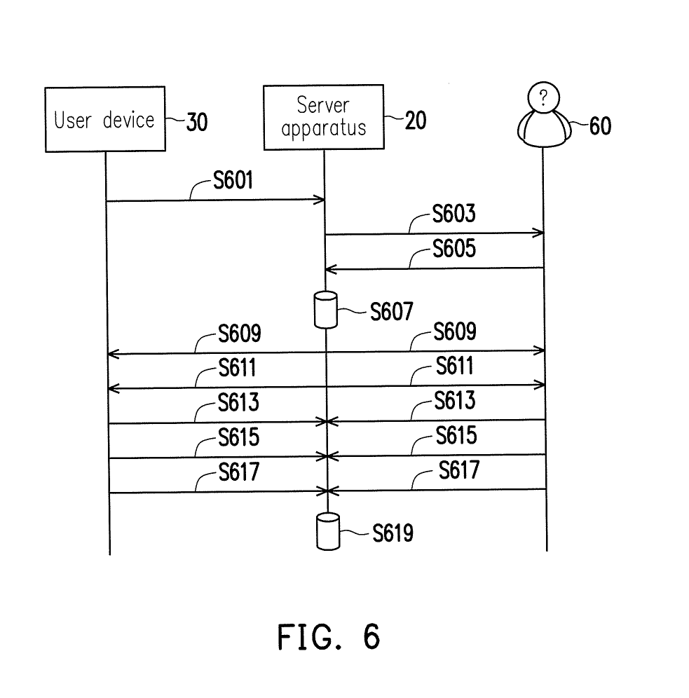

FIG. 6 is an example of a social communication system according to an exemplary embodiment of the invention. In the present exemplary embodiment, the user device 30 can be installed with an application program, and operations of the user are received through the application program, and the operations of the user are sent to the server apparatus 20. Referring to FIG. 6, the present example is adapted to the social communication system 10 of FIG. 1, and steps of the present example are described below with reference of the server apparatus 20 and the user device 30 of FIG.

First, in step S601, the application program installed on the user device 30 receives an operation of the user to send an anonymous social communication service request of the user to the server apparatus 20.

Then, in step S603, the server apparatus 20 receives the anonymous social communication service request sent by the user device 30, and sends (a pairing notice) the anonymous social communication service request to a candidate individual 60 in the FOF database of the user to inquire whether the candidate individual 60 agrees to carry on the anonymous social communication service. The server apparatus 20 can set a predetermined time and starts a countdown, and if no individual replies the anonymous social communication service request, the anonymous social communication service request is automatically time-out.

Then, in step S605, the server apparatus 20 receives a reply of agreeing to carry on the anonymous social communication service from the candidate individual 60.

Then, in step S607, the server apparatus 20 stores a pairing record. Moreover, in step S609, the server apparatus 20 provides the anonymous social communication service to the user and the candidate individual 60.

Then, in step S611, when the anonymous social communication service is stopped, the user device 30 and the candidate individual 60 respectively receive an inquiry from the server apparatus 20 to confirm whether the user and the candidate individual 60 are willing to provide their respective profiles. When both of the user and the candidate individual 60 are willing to provide their respective profiles, in step S613, the user and the candidate individual 60 are added to the respective friendship lists.

Moreover, in the step S611, when the anonymous social communication service is stopped, the user device 30 and the candidate individual 60 respectively receive the inquiry from the server apparatus 20 to confirm whether the user and the candidate individual 60 agree to continue the anonymous social communication service. When one of the user and the candidate individual 60 agrees to continue the anonymous social communication service and the other one agrees to provide the profile, in step S615, the server apparatus 20 continues the anonymous social communication service without providing the respective profiles of the user and the candidate individual 60.

Moreover, in the step S611, when the anonymous social communication service is stopped, the user device 30 and the candidate individual 60 respectively receive the inquiry from the server apparatus 20 to confirm whether the user and the candidate individual 60 agree to end the anonymous social communication service. When one of the user and the candidate individual 60 agrees to end the anonymous social communication service, in step S617, the server apparatus 20 ends the anonymous social communication service.

Finally, when the anonymous social communication service is ended, in step S619, the server apparatus 20 stores a course record of the anonymous social communication service.

Moreover, in an exemplary embodiment, the anonymous social communication service request may include the anonymous social communication service and a group anonymous social communication service. The server apparatus 20 may receive a group anonymous social communication service request sent by the user device 30, and sends (a pairing notification) the group anonymous social communication service request to a plurality of candidate individuals in the FOF database of the user to inquire whether the candidate individuals agree to carry on the group anonymous social communication service. Other implementation details of the example of the group anonymous social communication service are the same as that described above, and detail thereof is not repeated. It should be noticed that when the group anonymous social communication service is stopped, the server apparatus 20 sends the inquiry request to the user and a plurality of the candidate individuals. The inquiry request may contain options of whether agree to provide the respective profiles, whether agree to continue the group anonymous social communication service, and whether agree to end the group anonymous social communication service. To be specific, the server apparatus 20 can determine the replies of the user and the candidate individuals according to the conservative decision of the aforementioned table one, so as to determine a state of the group anonymous social communication service. In detail, for example, when at least one person agrees to end the group anonymous social communication service, though at least two people disagree to end the group anonymous social communication service, the server apparatus 20 allows the person who selects to end the group anonymous social communication service to leave the group anonymous social communication service, though the people who disagree to end the group anonymous social communication service stay to continue the group anonymous social communication service, and restarts the countdown. For example, when at most one person disagree to end the group anonymous social communication service, the server apparatus 20 can end the group anonymous social communication service. For example, when everyone is willing to provide the profile, the server apparatus 20 can provide the respective profiles to each other and add everyone to the respective friendship lists.

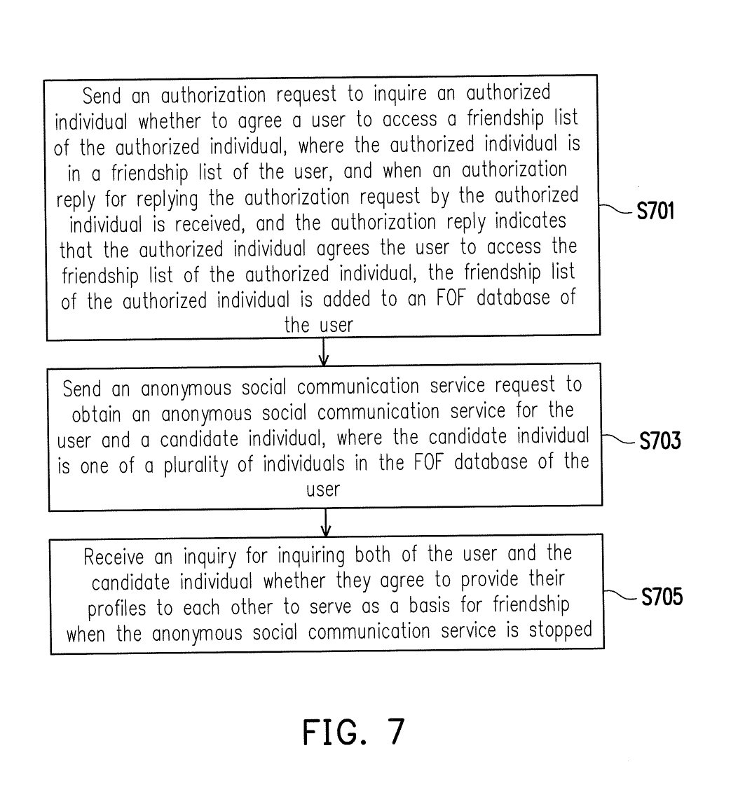

FIG. 7 is a flowchart illustrating a social communication method according to an exemplary embodiment of the invention. The present exemplary embodiment is adapted to the user device 30 of FIG. 1, and steps of the present exemplary embodiment are described below with reference of the user device 30 of FIG. 1.

Referring to FIG. 7, first, in step S701, the user device 30 sends an authorization request to inquire an authorized individual whether to agree a user to access a friendship list of the authorized individual, where the authorized individual is in a friendship list of the user. When an authorization reply for replying the authorization request by the authorized individual is received, and the authorization reply indicates that the authorized individual agrees the user to access the friendship list of the authorized individual, the friendship list of the authorized individual is added to an FOF database of the user.

Then, in step S703, the user device 30 sends an anonymous social communication service request to obtain an anonymous social communication service for the user and a candidate individual, where the candidate individual is one of a plurality of individuals in the FOF database of the user.

Finally, when the anonymous social communication service is stopped, in step S705, the user device 30 receives an inquiry for inquiring both of the user and the candidate individual whether they agree to provide their profiles to each other to serve as a basis for friendship.

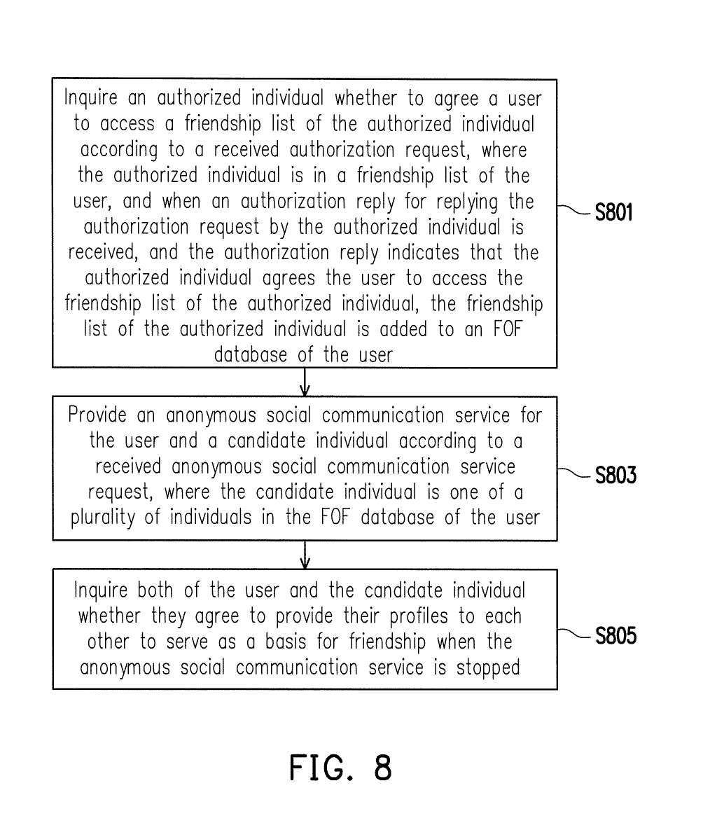

FIG. 8 is a flowchart illustrating a social communication method according to another exemplary embodiment of the invention. The present exemplary embodiment is adapted to the server apparatus 20 of FIG. 1, and steps of the present exemplary embodiment are described below with reference of the server apparatus 20 of FIG. 1.

Referring to FIG. 8, first, in step S801, the server apparatus 20 inquires an authorized individual whether to agree a user to access a friendship list of the authorized individual according to a received authorization request, where the authorized individual is in a friendship list of the user, and when an authorization reply for replying the authorization request by the authorized individual is received, and the authorization reply indicates that the authorized individual agrees the user to access the friendship list of the authorized individual, the friendship list of the authorized individual is added to an FOF database of the user.

Then, in step S803, the server apparatus 20 provides an anonymous social communication service for the user and a candidate individual according to a received anonymous social communication service request, where the candidate individual is one of a plurality of individuals in the FOF database of the user.

Finally, when the anonymous social communication service is stopped, in step S805, the server apparatus 20 inquires both of the user and the candidate individual whether they agree to provide their profiles to each other to serve as a basis for friendship.

In summary, the user can contact all of the friends of the user through the social communication system of the invention, and the user can request a specified friend for an authorization to access the friendship list of the specified friend, and when the specified friend agrees the authorization, the friendship lists of the user and the specified friend can be shared to create the FOF database. Moreover, the user can carry on the anonymous social communication service with any individual in the FOF database, and under the trust basis of having a mutual friend, security is improved. In addition, when the anonymous social communication service is stopped, the user and the individual of the anonymous social communication service are asked whether to exchange their profiles to each other or add each other as a friend, so as to achieve user's expectation of expanding the social circle. When the anonymous social communication service is ended, the course record is stored to increase security of the user.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A social communication system, comprising:
a server apparatus; and
a user device, sending an authorization request to make the server apparatus to inquire an authorized individual whether to agree a user to access a friendship list of the authorized individual, wherein the authorized individual is in a friendship list of the user, and when an authorization reply for replying the authorization request by the authorized individual is received, and the authorization reply indicates that the authorized individual agrees the user to access the friendship list of the authorized individual, the friendship list of the authorized individual is added to a friends of friends (FOF) database of the user,
wherein the user device sends an anonymous social communication service request to the server apparatus to obtain an anonymous social communication service for the user and a candidate individual, wherein the candidate individual is one of a plurality of individuals in the FOF database of the user,
wherein when the anonymous social communication service is stopped, the server apparatus inquires both of the user and the candidate individual whether they agree to provide their profiles to each other to serve as a basis for friendship of the user and the candidate individual.

2. The social communication system as claimed in claim 1, wherein when the user and the candidate individual all agree to provide their profiles to each other, the server apparatus adds the user to the friendship list of the candidate individual and the candidate individual to the friendship list of the user.

3. The social communication system as claimed in claim 1, wherein when the anonymous social communication service is provided, a predetermined time is set to start a countdown, and when the countdown of the predetermined time is finished, the anonymous social communication service is stopped.

4. The social communication system as claimed in claim 1, wherein when the anonymous social communication service is ended, the server apparatus stores a course record of the anonymous social communication service.

5. The social communication system as claimed in claim 1, wherein when the anonymous social communication service is stopped, the server apparatus inquires both of the user and the candidate individual whether they agree to continue the anonymous social communication service, and when one of the user and the candidate individual agree to continue the anonymous social communication service, and the other one agrees to provide the profile, the server apparatus continues the anonymous social communication service without providing the respective profiles of the user and the candidate individual to each other.

6. The social communication system as claimed in claim 1, wherein when the anonymous social communication service is stopped, the server apparatus inquires both of the user and the candidate individual whether they agree to end the anonymous social communication service, and when one of the user and the candidate individual agrees to end the anonymous social communication service, the server apparatus ends the anonymous social communication service.

7. The social communication system as claimed in claim 1, wherein when the server apparatus provides the anonymous social communication service, the server apparatus provides at least one mutual friend profile to the user and the candidate individual to serve as a communication basis of the user and the candidate individual.

8. A social communication method, adapted to a user device, comprising:
sending an authorization request to inquire an authorized individual whether to agree a user to access a friendship list of the authorized individual, wherein the authorized individual is in a friendship list of the user, and when an authorization reply for replying the authorization request by the authorized individual is received, and the authorization reply indicates that the authorized individual agrees the user to access the friendship list of the authorized individual, the friendship list of the authorized individual is added to a friends of friends (FOF) database of the user;
sending an anonymous social communication service request to obtain an anonymous social communication service for the user and a candidate individual, wherein the candidate individual is one of a plurality of individuals in the FOF database of the user; and
receiving an inquiry for inquiring both of the user and the candidate individual whether they agree to provide their profiles to each other to serve as a basis for friendship of the user and the candidate individual when the anonymous social communication service is stopped.

9. The social communication method as claimed in claim 8, further comprising:
adding the user to the friendship list of the candidate individual and the candidate individual to the friendship list of the user when the user and the candidate individual all agree to provide their profiles to each other.

10. The social communication method as claimed in claim 8, further comprising:
storing a course record of the anonymous social communication service when the anonymous social communication service is ended.

11. The social communication method as claimed in claim 8, further comprising:
receiving an inquiry for inquiring both of the user and the candidate individual whether they agree to continue the anonymous social communication service when the anonymous social communication service is stopped, wherein when one of the user and the candidate individual agree to continue the anonymous social communication service, and the other one agrees to provide the profile, the anonymous social communication service is continued without providing the respective profiles of the user and the candidate individual to each other.

12. The social communication method as claimed in claim 8, further comprising:
receiving an inquiry for inquiring both of the user and the candidate individual whether they agree to end the anonymous social communication service when the anonymous social communication service is stopped, wherein when one of the user and the candidate individual agrees to end the anonymous social communication service, the anonymous social communication service is ended.

13. The social communication method as claimed in claim 8, further comprising:
the user and the candidate individual obtaining at least one mutual friend profile to serve as a communication basis of the user and the candidate individual when the anonymous social communication service is provided.

14. A social communication method, adapted to a server apparatus, comprising:
inquiring an authorized individual whether to agree a user to access a friendship list of the authorized individual according to a received authorization request, wherein the authorized individual is in a friendship list of the user, and when an authorization reply for replying the authorization request by the authorized individual is received, and the authorization reply indicates that the authorized individual agrees the user to access the friendship list of the authorized individual, the friendship list of the authorized individual is added to a friends of friends (FOF) database of the user;
providing an anonymous social communication service for the user and a candidate individual according to a received anonymous social communication service request, wherein the candidate individual is one of a plurality of individuals in the FOF database of the user; and
inquiring both of the user and the candidate individual whether they agree to provide their profiles to each other to serve as a basis for friendship of the user and the candidate individual when the anonymous social communication service is stopped.

15. The social communication method as claimed in claim 14, further comprising:
adding the user to the friendship list of the candidate individual and the candidate individual to the friendship list of the user when the user and the candidate individual all agree to provide their profiles to each other.

16. The social communication method as claimed in claim 14, further comprising:
setting a predetermined time to start a countdown when the anonymous social communication service is provided, wherein when the countdown of the predetermined time is finished, the anonymous social communication service is stopped.

17. The social communication method as claimed in claim 14, further comprising:
storing a course record of the anonymous social communication service when the anonymous social communication service is ended.

18. The social communication method as claimed in claim 14, further comprising:
inquiring both of the user and the candidate individual whether they agree to continue the anonymous social communication service when the anonymous social communication service is stopped, wherein when one of the user and the candidate individual agree to continue the anonymous social communication service, and the other one agrees to provide the profile, the anonymous social communication service is continued without providing the respective profiles of the user and the candidate individual to each other.

19. The social communication method as claimed in claim 14, further comprising:
inquiring both of the user and the candidate individual whether they agree to end the anonymous social communication service when the anonymous social communication service is stopped, wherein when one of the user and the candidate individual agrees to end the anonymous social communication service, the anonymous social communication service is ended.

20. The social communication method as claimed in claim 14, further comprising:
providing at least one mutual friend profile to the user and the candidate individual to serve as a communication basis of the user and the candidate individual when the anonymous social communication service is provided.
